(19) United States
(12) Patent Application Publication
(10) Pub. No.: US 2020/0123379 A1
(43) Pub. Date: Apr. 23, 2020

(54) TOUGHENED, HIGH CONDUCTIVITY EMI THERMOPLASTIC WITH NANOMATERIALS AND ARTICLES AND METHODS THEREOF

(71) Applicant: Lockheed Martin Corporation, Bethesda, MD (US)

(72) Inventors: James A. WAICUKAUSKI, Bel Air, MD (US); Venugopala Rao BASAVA, Perry Hall, MD (US)

(73) Assignee: Lockheed Martin Corporation, Bethesda, MD (US)

(21) Appl. No.: 16/168,314

(22) Filed: Oct. 23, 2018

(51) Int. Cl. C08L 75/04; C08K 3/04; C08K 9/02; B29C 64/118; B29C 64/153

(52) U.S. Cl. CPC C08L 75/04; C08K 3/041; C08K 3/042; C08K 9/02; B33Y 30/00; B29C 64/153; C08K 2201/001; C08K 2201/005; B29C 64/118

(57) ABSTRACT

A toughened thermoplastic composition containing thermoplastic polyurethane, carbon nanostructures, and graphite microparticles coated with at least one metal. The toughened thermoplastic composition is an injectable moldable grade thermoplastic composition, with developed processing properties compatible with fused filament fabrication additive manufacturing, EMI shielding, and electrical grounding. The composition contains an electrically conductive polymer composite, the composite containing: at least one thermoplastic material containing thermoplastic polyurethane; at least one electrically conductive material containing carbon nanostructures; and at least one graphite microparticle coated with at least one metal.

The present disclosure relates to a thermoplastic composition, particularly a toughened thermoplastic composition that can contain or comprise thermoplastic polyurethane, carbon nanostructures, and graphite microparticles coated with metals and articles and methods thereof.

### SUMMARY

According to one or more embodiments of the disclosed subject matter, a composition comprising an electrically conductive polymer composite is described or provided. The composite can include at least one thermoplastic material comprising thermoplastic polyurethane; at least one electrically conductive material comprising carbon nanostructures; and at least one graphite microparticle coated with metals.

One or more embodiments of the disclosed subject matter can also involve a method of preparing the aforementioned composition. The method can comprise: (a) combining the particulate thermoplastic material comprising thermoplastic polyurethane, the electrically conductive material comprising carbon nanostructures and the graphite microparticle coated with metals in a liquid dispersing medium to form at least one mixture; (b) subjecting the mixture to sufficient agitation under high shear to provide a substantially uniform dispersion; and (c) substantially removing the liquid dispersing medium from the dispersion of the subjecting (b) to form the composite, where the particulate thermoplastic material and the carbon nanostructures are distributed substantially uniformly in the composite, and substantially uniformly coated with the at least one graphite microparticle coated with metals.

Additionally, one or more embodiments of the disclosed subject matter can pertain to a method of forming a three-dimensional article of manufacture from a composition comprising an electrically conductive polymer composite, the composite including: at least one thermoplastic material comprising thermoplastic polyurethane; at least one electrically conductive material comprising carbon nanostructures; and at least one graphite microparticle coated with metals. The method can comprise: providing the composition; and forming the three-dimensional article of manufacture out of the provided composition.

The preceding summary is to provide an understanding of some aspects of the disclosure. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

The accompanying drawings, which are incorporated in and constitute a part of the specification, are illustrative of one or more embodiments of the disclosed subject matter, and, together with the description, explain various embodiments of the disclosed subject matter. Further, the accompanying drawings have not necessarily been drawn to scale, and any values or dimensions in the accompanying drawings are for illustration purposes only and may or may not represent actual or preferred values or dimensions. Where applicable, some or all select features may not be illustrated to assist in the description and understanding of underlying features.

FIG. 1 is a flow chart of a method according to one or more embodiments of the disclosed subject matter.

FIG. 2 is a graph demonstrating shielding effectiveness (dB) vs. frequency (GHz) of Example 1, which is an embodiment according to the disclosure.

FIG. 3 shows an article of manufacture in the form of a case and/or a cover made using a composition according to one or more embodiments of the disclosed subject matter.

FIG. 4 shows an article of manufacture in the form of a support structure made using a composition according to one or more embodiments of the disclosed subject matter.

### DETAILED DISCLOSURE

The description set forth below in connection with the appended drawings is intended as a description of various embodiments of the described subject matter and is not necessarily intended to represent the only embodiment(s). In certain instances, the description includes specific details for the purpose of providing an understanding of the described subject matter. However, it will be apparent to those skilled in the art that embodiments may be practiced without these specific details. In some instances, structures and components may be shown in block diagram form in order to avoid obscuring the concepts of the described subject matter. Wherever possible, the same reference numbers will be used throughout the drawings to refer to the same or the like parts.

Any reference in the specification to “one embodiment” or “an embodiment” means that a particular feature, structure, characteristic, operation, or function described in connection with an embodiment is included in at least one embodiment. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments, and it is intended that embodiments of the described subject matter can and do cover modifications and variations of the described embodiments.

It must also be noted that, as used in the specification, appended claims and abstract, the singular forms “a,” “an,” and “the” include plural referents unless the context clearly dictates otherwise. That is, unless clearly specified otherwise, as used herein the words “a” and “an” and the like carry the meaning of “one or more” or “at least one.” The phrases “at least one,” “one or more,” “or,” and “and/or” are open-ended expressions that can be both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” can mean A alone, B alone, C alone, A and B together, A and C together, B and C together, or A, B and C together. It is also to be noted that the terms “comprising,” “including,” and “having” can be used interchangeably and are inclusive and, therefore, specify the presence of stated items, but do not preclude the presence of other items.

All disclosures of ranges include the endpoints of the ranges and are disclosures of all values and further divided ranges within the entire range. Also, all values and subranges within a numerical limit or range are specifically included as if explicitly written out. Further, all references, patents, applications, tests, standards, documents, publications, brochures, texts, articles, etc. mentioned herein are incorporated herein by reference in their entirety.

As noted above, embodiments of the present disclosure involve a thermoplastic composition, particularly a toughened thermoplastic composition. The toughened thermoplastic composition can contain or comprise thermoplastic polyurethane, carbon nanostructures, and graphite microparticles coated with metals, for instance. The toughened thermoplastic composition can be an injection moldable grade thermoplastic composition, with developed processing properties compatible with fused filament fabrication additive manufacturing, electromagnetic interference shielding, and electrical grounding. Optionally, toughened thermoplastic compositions according to embodiments of the disclosed subject matter can be additionally or alternatively implemented in additive manufacturing.

There are two basic types of plastic: thermosetting, which cannot be re-softened after being subjected to heat and pressure; and thermoplastic, which can be repeatedly softened and remolded by heat and pressure. When heat and pressure are applied to a thermoplastic binder, the chainlike polymers slide past each other, giving the material plasticity. However, when heat and pressure are initially applied to a thermosetting binder, the molecular chains become crosslinked, thus preventing any slippage if heat and pressure are reapplied.

Additive manufacturing, which may be referred to as three-dimensional (3D) printing, may create physical articles (e.g., objects, device, component, structures, or parts) based upon a computer-controlled program which instructs the 3D printer how to deposit successive layers of extruded material which may then fuse together to form the printed article. Fused deposition modeling (FDM), which may be referred to as fused filament fabrication (FFF), is one such additive manufacturing process. Other 3D printing techniques may include selective laser sintering (SLS) techniques and inkjet printing techniques. When using an electrically conductive thermoplastic composite in the form of a filament pellet or powder, such 3D printing techniques may form or create printable electronics, such as circuitry and power sources which may then be incorporated directly into functional printed articles, devices, components and parts.

Plastic materials may be used as the filament material for 3D printing. For example, acrylonitrile butadiene styrene (ABS) and polylactic acid (PLA) are used for an FDM-type printer. However, such plastic materials, used alone, may have unsuitable strength, durability, and/or conductivity characteristics. More specifically, ABS, alone, can have some acceptable mechanical properties, but can suffer from relatively large volumetric shrinkage and the generation of unpleasant odors. PLA, on the other hand, alone, can have less volumetric shrinkage, which can allow printing without a heated build envelope.

In order to enable the successful three-dimensional (3D) printing of thermoplastic composites, in particular electrically conductive thermoplastic composites, not only does melt rheology need to be taken into account, but also certain mechanical properties of the materials present in these composites in their solid state. In other words, a complex combination of the materials in such composites delivering the right combination of mechanical properties in the solid state as well as suitable melt viscoelastic properties may be required to enable successful three-dimensional (3D) printing of such composites. In addition, in carrying out injection molding, fused filament fabrication (FFF) techniques, and selective laser sintering (SLS) fabrication techniques with such composites, the viscoelastic behavior of the material present in such composites when in a molten state may also play a significant role in successfully carrying out such techniques.

According to embodiments of the disclosed subject matter, an electrically conductive material can be incorporated into such composites. As a non-limiting example, one electrically conductive material which may be incorporated is carbon nanostructures (CNS). Generally, CNS may exist as discontinuous, highly graphitic materials, may also be highly compatible with certain polymer processing techniques, and thus may be dispersed in isotropic or anisotropic mode. CNS may exhibit suitable mechanical properties, may have relatively high electrical and thermal conductivities, and may be compatible with a wide range of materials. Carbon nanofiber surfaces may also be functionalized to improve their compatibility with the polymer matrix present in the composite, or to render such carbon nanofibers more useful for specific applications. When incorporated into thermoplastic polymer-containing composites according to one or more embodiments of the disclosed subject matter, these carbon nanofibers (along with any other electrically conductive components such as graphite nano and micro platelets and/or conductive metal nano and micro particulates) may increase tensile strength, compression strength, Young's modulus, interlaminar shear strength, and fracture toughness, as well as vibration damping of the polymer-containing composite.

In one or more embodiments, a composition can comprise an electrically conductive polymer composite, where the composite can comprise: at least one thermoplastic material comprising thermoplastic polyurethane; at least one electrically conductive material comprising carbon nanostructures; and at least one graphite microparticle coated with metals, for instance.

Thermoplastic Polyurethanes (TPU)

The thermoplastic polyurethanes according to embodiments of the disclosed subject matter can be derived from (a) a polyisocyanate component, (b) a polyol component, and (c) an optional chain extender component, wherein the resulting thermoplastic polyurethane can meet the parameters described herein.

The TPU compositions described herein, according to embodiments of the disclosed subject matter, can be made using (a) a polyisocyanate component. The polyisocyanate and/or polyisocyanate component can include one or more polyisocyanates. In some embodiments, the polyisocyanate component includes one or more diisocyanates.

In some embodiments, the polyisocyanate and/or polyisocyanate component can include an alpha, omega-alkylene diisocyanate having from 5 to 20 carbon atoms.

Suitable polyisocyanates include aromatic diisocyanates, aliphatic diisocyanates, or combinations thereof. In some embodiments, the polyisocyanate component includes one or more aromatic diisocyanates. In some embodiments, the polyisocyanate component is essentially free of, or even completely free of, aliphatic diisocyanates. In other embodiments, the polyisocyanate component includes one or more aliphatic diisocyanates. In some embodiments, the polyisocyanate component is essentially free of, or even completely free of, aromatic diisocyanates.

Examples of polyisocyanates used according to embodiments of the disclosed subject matter include aromatic diisocyanates such as 4,4′-methylenebis(phenyl isocyanate) (MDI), m-xylene diisocyanate (XDI), phenylene-1,4-diisocyanate, naphthalene-1,5-diisocyanate, and toluene diisocyanate (TDI); as well as aliphatic diisocyanates such as isophorone diisocyanate (IPDI), 1,4-cyclohexyl diisocyanate (CHDI), decane-1,10-diisocyanate, lysine diisocyanate (LDI), 1,4-butane diisocyanate (BDI), isophorone diisocyanate (PDI), 3,3′-dimethyl-4,4′-biphenylene diisocyanate (TODI), 1,5-naphthalene diisocyanate (NDI), and dicyclohexylmethane-4,4′-diisocyanate (H12MDI). Mixtures of two or more polyisocyanates may be used. In some embodiments, the polyisocyanate is MDI and/or H12MDI. In some embodiments, the polyisocyanate includes MDI. In some embodiments, the polyisocyanate includes H12MDI.

In some embodiments, the polyisocyanate used to prepare the TPU and/or TPU compositions described herein can be at least 50%, on a weight basis, a cycloaliphatic diisocyanate. In some embodiments, the polyisocyanate can include an alpha, omega-alkylene diisocyanate having from 5 to 20 carbon atoms.

In some embodiments, the polyisocyanate used to prepare the TPU and/or TPU compositions described herein can include hexamethylene-1,6-diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, or any combination thereof.

In some embodiments, the polyisocyanate component can comprise an aromatic diisocyanate. In some embodiments, the polyisocyanate component comprises 4,4′-methylenebis(phenyl isocyanate).

TPU compositions according to embodiments of the disclosed subject matter can be made using (b) a polyol component. Polyols include polyether polyols, polyester polyols, polycarbonate polyols, polysiloxane polyols, and combinations thereof. Suitable polyols, which may also be described as hydroxyl terminated intermediates, when present, may include one or more hydroxyl terminated polyesters, one or more hydroxyl terminated polyethers, one or more hydroxyl terminated polycarbonates, one or more hydroxyl terminated polysiloxanes, or mixtures thereof.

Suitable hydroxyl terminated polyester intermediates according to embodiments of the disclosed subject matter can include linear polyesters having a number average molecular weight (Mn) of from about 500 to about 10,000, preferably from about 700 to about 5,000, especially preferably from about 700 to about 4,000, and generally have an acid number less than 1.3, preferably less than 0.5. The molecular weight can be determined by assay of the terminal functional groups and is related to the number average molecular weight. The polyester intermediates may be produced by an esterification reaction of one or more glycols with one or more dicarboxylic acids or anhydrides or by transesterification reaction, i.e., the reaction of one or more glycols with esters of dicarboxylic acids. Mole ratios generally in excess of more than one mole of glycol to acid are preferred so as to obtain linear chains having a preponderance of terminal hydroxyl groups. Suitable polyester intermediates also include various lactones such as polycaprolactone typically made from ε-caprolactone and a bifunctional initiator such as diethylene glycol. The dicarboxylic acids of the desired polyester can be aliphatic, cycloaliphatic, aromatic, or combinations thereof. Suitable dicarboxylic acids which may be used alone or in mixtures generally have a total of from 4 to 15 carbon atoms and include: succinic, glutaric, adipic, pimelic, suberic, azelaic, sebacic, dodecanedioic, isophthalic, terephthalic, cyclohexane dicarboxylic, and the like. Anhydrides of the above dicarboxylic acids such as phthalic anhydride, tetrahydrophthalic anhydride, or the like, can also be used. Adipic acid is a preferred acid. The glycols which are reacted to form a desirable polyester intermediate can be aliphatic, aromatic, or combinations thereof, including any of the glycols described above in the chain extender section, and have a total of from 2 to 20, preferably from 2 to 12 carbon atoms. Suitable examples include ethylene glycol, 1,2-propanediol, 1,3-propanediol, 1,3-butanediol, 1,4-butanediol, 1,5-pentanediol, 1,6-hexanediol, 2,2-dimethyl-1,3-propanediol, 1,4-cyclohexanedimethanol, decamethylene glycol, dodecamethylene glycol, and mixtures thereof.

The polyol component may also include one or more polycaprolactone polyester polyols. Polycaprolactone polyester polyols according to embodiments of the disclosed subject matter can include polyester diols derived from caprolactone monomers. The polycaprolactone polyester polyols can be terminated by primary hydroxyl groups. Suitable polycaprolactone polyester polyols may be made from ε-caprolactone and a bifunctional initiator such as diethylene glycol, 1,4-butanediol, or any of the other glycols and/or diols listed herein. In some embodiments, the polycaprolactone polyester polyols are linear polyester diols derived from caprolactone monomers.

Suitable hydroxyl terminated polyether intermediates include polyether polyols derived from a diol or polyol having a total of from 2 to 15 carbon atoms, in some embodiments an alkyl diol or glycol which is reacted with an ether comprising an alkylene oxide having from 2 to 6 carbon atoms, typically ethylene oxide or propylene oxide or mixtures thereof. For example, hydroxyl functional polyether can be produced by first reacting propylene glycol with propylene oxide followed by subsequent reaction with ethylene oxide. Primary hydroxyl groups resulting from ethylene oxide are more reactive than secondary hydroxyl groups and thus are preferred. Useful commercial polyether polyols include poly(ethylene glycol) comprising ethylene oxide reacted with ethylene glycol, poly(propylene glycol) comprising propylene oxide reacted with propylene glycol, poly(tetramethylene ether glycol) comprising water reacted with tetrahydrofuran which can also be described as polymerized tetrahydrofuran, and which is commonly referred to as PTMEG. In some embodiments, the polyether intermediate includes PTMEG. Suitable polyether polyols also include polyamide adducts of an alkylene oxide and can include, for example, ethylenediamine adduct comprising the reaction product of ethylenediamine and propylene oxide, diethylenetriamine adduct comprising the reaction product of diethylenetriamine with propylene oxide, and similar polyamide type polyether polyols. Copolyethers can also be utilized in the described compositions. Typical copolyethers include the reaction product of THF and ethylene oxide or THF and propylene oxide. These are available from BASF as PolyTHF® B, a block copolymer, and poly THF® R, a random copolymer. The various polyether intermediates generally have a number average molecular weight (Mn) as determined by assay of the terminal functional groups which is an average molecular weight greater than about 700, such as from about 700 to about 10,000, preferably from about 1,000 to about 5,000, especially preferably from about 1,000 to about 2,500. In some embodiments, the polyether intermediate includes a blend of two or more different molecular weight polyethers, such as a blend of 2,000 Mₙ and 1,000 Mₙ PTMEG.

Suitable hydroxyl terminated polycarbonates include those prepared by reacting a glycol with a carbonate. U.S. Pat. No. 4,131,731 is hereby incorporated by reference in its entirety for its disclosure of hydroxyl terminated polycarbonates and their preparation. Such polycarbonates are linear and have terminal hydroxyl groups with essential exclusion of other terminal groups. The essential reactants are glycols and carbonates. Suitable glycols are selected from aliphatic diols containing 4 to 40, preferably 4 to 12 carbon atoms, and from polyoxyalkylene glycols containing 2 to 20 alkoxy groups per molecule with each alkoxy group containing 2 to 4 carbon atoms. Suitable diols include aliphatic diols containing 4 to 12 carbon atoms such as 1,4-butanediol, 1,5-pentanediol, neopentyl glycol, 1,6-hexanediol, 2,2,4-trimethyl-1,6-hexanediol, 1,10-decanediol, hydrogenated dilinoleylglycol, hydrogenated dioleylglycol, 3-methyl-1,5-pentanediol; and cycloaliphatic diols such as 1,3-cyclohexanediol, 1,4-dimethylolcyclohexane, 1,4-cyclohexanediol-, 1,3-dimethylolcyclohexane-, 1,4-endomethylene-2-hydroxy-5-hydroxymethyl cyclohexane, and polyalkylene glycols. The diols used in the reaction may be a single diol or a mixture of diols depending on the properties desired in the finished product. Polycarbonate intermediates which are hydroxyl terminated are generally those known to the art and in the literature. Suitable carbonates are selected from alkylene carbonates composed of a 5 to 7 member ring. Suitable carbonates for use herein include ethylene carbonate, trimethylene carbonate, tetramethylene carbonate, 1,2-propylene carbonate, 1,2-butylene carbonate, 2,3-butylene carbonate, 1,2-ethylene carbonate, 1,3-pentylene carbonate, 1,4-pentylene carbonate, 2,3-pentylene carbonate, and 2,4-pentylene carbonate. Also, suitable herein are dialkylcarbonates, cycloaliphatic carbonates, and diarylcarbonates. The dialkylcarbonates can contain 2 to 5 carbon atoms in each alkyl group and specific examples thereof are diethylcarbonate and dipropylcarbonate. Cycloaliphatic carbonates, especially dicycloaliphatic carbonates, can contain 4 to 7 carbon atoms in each cyclic structure, and there can be one or two of such structures. When one group is cycloaliphatic, the other can be either alkyl or aryl. On the other hand, if one group is aryl, the other can be alkyl or cycloaliphatic. Examples of suitable diarylcarbonates, which can contain 6 to 20 carbon atoms in each aryl group, for instance, include diphenylcarbonate, ditolylcarbonate, and dinaphthylcarbonate.

Suitable polysiloxane polyols include alpha-omega-hydroxyl or amine or carboxylic acid or thiol or epoxy terminated polysiloxanes. Examples include poly(dimethysiloxane) terminated with a hydroxyl or amine or carboxylic acid or thiol or epoxy group. In some embodiments, the polysiloxane polyols are hydroxyl terminated polysiloxanes. In some embodiments, the polysiloxane polyols have a number-average molecular weight in the range from 300 to 5,000, preferably from 400 to 3,000, for instance.

Polysiloxane polyols may be obtained by the dehydrogenation reaction between a polysiloxane hydride and an aliphatic polyhydric alcohol or polyoxyalkylene alcohol to introduce the alcoholic hydroxy groups onto the polysiloxane backbone. Suitable examples include alpha-omega-hydroxypropyl terminated poly(dimethysiloxane) and alpha-omega-amino propyl terminated poly(dimethysiloxane), both of which are commercially available materials. Further examples include copolymers of the poly(dimethysiloxane) materials with poly(alkylene oxide).

The polyol component, when present, may include poly(ethylene glycol), poly(tetramethylene ether glycol), poly(trimethylene oxide), ethylene oxide capped poly(propylene glycol), poly(butylene adipate), poly(ethylene adipate), poly(hexamethylene adipate), poly(tetramethylene-co-hexamethylene adipate), poly(3-methyl-1,5-pentamethylene adipate), polycaprolactone diol, poly(hexamethylene carbonate) glycol, poly(pentamethylene carbonate) glycol, poly(trimethylene carbonate) glycol, dimer fatty acid based polyester polyols, vegetable oil based polyols, or any combination thereof.

Examples of dimer fatty acids that may be used to prepare suitable polyester polyols include Priplast™ polyester glycols/polyols commercially available from Croda and Radia® polyester glycols commercially available from Oleon.

In some embodiments, the polyol component includes a polyether polyol, a polycarbonate polyol, a polycaprolactone polyol, or any combination thereof. In some embodiments, the polyol component includes a polyether polyol. In some embodiments, the polyol component is essentially free of or even completely free of polyester polyols. In some embodiments, the polyol component used to prepare the TPU is substantially free of, or even completely free of polysiloxanes. In some embodiments, the polyol component includes ethylene oxide, propylene oxide, butylene oxide, styrene oxide, poly(tetramethylene ether glycol), poly(propylene glycol), poly(ethylene glycol), copolymers of poly(ethylene glycol) and poly(propylene glycol), epichlorohydrin, and the like, or combinations thereof. In some embodiments, the polyol component includes poly(tetramethylene ether glycol).

In some embodiments the polyol has a number average molecular weight ranging from 900 to 5,000, preferably from 1,000 to 4,000, particularly preferably from 1,500 to 3,000, especially preferably from 1,750 to 2,500, or about 2,000, for instance.

In some embodiments, the polyol component comprises a polycaprolactone polyester polyether polyol, a polyether polyol, a polycaprolactone polyester polyether copolymer polyol, a polyester polyol, or any combination thereof.

In some embodiments, the polyol component comprises a polycaprolactone polyester polyether polyol, a poly(tetramethylene ether glycol), a polycaprolactone polyester poly(tetramethylene ether glycol) copolymer polyol, a polybutylene adipate, a polybutylene-hexylene adipate (an adipate made from a mixture of 1,4-butanediol and 1,6-hexanediol), or any combination thereof. In some embodiments, the polyol component comprises a polycaprolactone polyester poly(tetramethylene ether glycol) copolymer polyol.

The TPU compositions described herein can be made using c) a chain extender component. Chain extenders include diols, diamines, and any combination thereof.

Suitable chain extenders include relatively small polyhydroxy compounds, for example, lower aliphatic or short chain glycols having from 2 to 20, preferably 2 to 12, especially preferably 2 to 10 carbon atoms. Suitable examples include ethylene glycol, diethylene glycol, propylene glycol, dipropylene glycol, 1,4-butanediol (BDO), 1,6-hexanediol (HDO), 1,3-butanediol, 1,5-pentanediol, neopentylglycol, 1,4-cyclohexanedimethanol (CHDM), 2,2-bis[4-(2-hydroxyethoxy) phenyljpropane (HEPP), hexamethylenediol, heptanediol, nonanediol, dodecanediol, 3-methyl-1,5-pentanediol, ethylenediamine, butanediamine, hexamethylenediamine, and hydroxyethyl resorcinol (HER), and the like, as well as mixtures thereof. In some embodiments, the chain extender includes BDO, HDO, 3-methyl-1,5-pentanediol, or any combination thereof. In some embodiments, the chain extender includes BDO. Other glycols, such as aromatic glycols could be used, but in some embodiments the TPUs described herein are essentially free of or even completely free of such materials.

In some embodiments, the chain extender used to prepare the TPU is substantially free of, or even completely free of, 1,6-hexanediol. In some embodiments, the chain extender used to prepare the TPU includes a cyclic chain extender. Suitable examples include CHDM, HEPP, HER, and combinations thereof. In some embodiments, the chain extender used to prepare the TPU includes an aromatic cyclic chain extender, for example, HEPP, HER, or a combination thereof. In some embodiments, the chain extender used to prepare the TPU includes an aliphatic cyclic chain extender, for example, CHDM. In some embodiments, the chain extender used to prepare the TPU is substantially free of, or even completely free of aromatic chain extenders, for example, aromatic cyclic chain extenders. In some embodiments, the chain extender used to prepare the TPU is substantially free of, or even completely free of polysiloxanes.

In some embodiments, the chain extender component includes 1,4-butanediol, 2-ethyl-1,3-hexanediol, 2,2,4-trimethyl pentane-1,3-diol, 1,6-hexanediol, 1,4-cyclohexane dimethylol, 1,3-propanediol, 3-methyl-1,5-pentanediol or combinations thereof. In some embodiments, the chain extender component includes 1,4-butanediol, 3-methyl-1,5-pentanediol or combinations thereof. In some embodiments, the chain extender component includes 1,4-butanediol.

In some embodiments, the chain extender component comprises a linear alkylene diol. In some embodiments, the chain extender component comprises 1,4-butanediol, dipropylene glycol, or a combination of the two. In some embodiments, the chain extender component comprises 1,4-butanediol.

In some embodiments, the mole ratio of the chain extender to the polyol is greater than 1.5. In other embodiments, the mole ratio of the chain extender to the polyol is from 1.5 to 5.0, preferably from 2.0 to 4.0, particularly preferably from 3.5 to 3.8, and especially preferably about 3.7.

Thermoplastic polyurethanes according to embodiments of the disclosed subject matter may also be considered to be thermoplastic polyurethane (TPU) compositions. In such embodiments, the compositions may contain one or more TPU. These TPU can be prepared by reacting: a) the polyisocyanate component described above; b) the polyol component described above; and c) the chain extender component described above, where the reaction may be carried out in the presence of a catalyst. According to one or more embodiments, at least one of the TPU in the composition meets the parameters described above making it suitable for solid freeform fabrication, and in particular fused deposition modeling.

The means by which the reaction is carried out is not overly limited, and includes both batch and continuous processing. In some embodiments, the technology deals with batch processing of aliphatic TPU. In some embodiments, the technology deals with continuous processing of aliphatic TPU. The described compositions include the TPU materials described above, and also TPU compositions that include such TPU materials and one or more additional components. These additional components can include other polymeric materials that may be blended with the TPU described herein. These additional components include one or more additives that may be added to the TPU, or blend containing the TPU, to impact the properties of the composition.

TPU according to embodiments of the disclosed subject matter may also be blended with one or more other polymers. The polymers with which the TPU may be blended are not overly limited. In some embodiments, the described compositions include two or more of the described TPU materials. In some embodiments, the compositions include at least one of the described TPU materials and at least one other polymer, which is not one of the described TPU materials.

Polymers that may be used in combination with the TPU materials described herein also include more conventional TPU materials such as non-caprolactone polyester-based TPU, polyether-based TPU, or TPU containing both non-caprolactone polyester and polyether groups. Other suitable materials that may be blended with the TPU materials described herein include polycarbonates, polyolefins, styrenic polymers, acrylic polymers, polyoxymethylene polymers, polyamides, polyphenylene oxides, polyphenylene sulfides, polyvinylchlorides, chlorinated polyvinylchlorides, polylactic acids, or combinations thereof.

Polymers for use in the blends described herein include homopolymers and copolymers. Suitable examples include: a polyolefin (PO), such as polyethylene (PE), polypropylene (PP), polybutene, ethylene propylene rubber (EPR), polyoxyethylene (POE), cyclic olefin copolymer (COC), or combinations thereof; a styrenic, such as polystyrene (PS), acrylonitrile butadiene styrene (ABS), styrene acrylonitrile (SAN), styrene butadiene rubber (SBR or HIPS), polyalphamethylstyrene, styrene maleic anhydride (SMA), styrene-butadiene copolymer (SBC) (such as styrene-butadiene-styrene copolymer (SBS) and styrene-ethylene/butadiene-styrene copolymer (SEBS)), styrene-ethylene/propylene-styrene copolymer (SEPS), styrene butadiene latex (SBL), SAN modified with ethylene propylene diene monomer (EPDM) and/or acrylic elastomers (for example, PS-SBR copolymers), or combinations thereof a thermoplastic polyurethane (TPU) other than those described above; a polyamide, such as Nylon™, including polyamide 6,6 (PA66), polyamide 1,1 (PA11), polyamide 1,2 (PA12), a copolyamide (COPA), or combinations thereof; an acrylic polymer, such as polymethyl acrylate, polymethylmethacrylate, a methyl methacrylate styrene (MS) copolymer, or combinations thereof; a polyvinylchloride (PVC), a chlorinated polyvinylchloride (CPVC), or combinations thereof a polyoxyemethylene, such as polyacetal; a polyester, such as polyethylene terephthalate (PET), polybutylene terephthalate (PBT), copolyesters and/or polyester elastomers (COPE) including polyether-ester block copolymers such as glycol modified polyethylene terephthalate (PETG), polylactic acid (PLA), polyglycolic acid (PGA), copolymers of PLA and PGA, or combinations thereof; a polycarbonate (PC), a polyphenylene sulfide (PPS), a polyphenylene oxide (PPO), or combinations thereof; or combinations thereof.

Additional additives suitable for use in the TPU compositions described herein are not overly limited. Suitable additives include pigments, UV stabilizers, UV absorbers, antioxidants, lubricity agents, heat stabilizers, hydrolysis stabilizers, cross-linking activators, flame retardants, layered silicates, fillers, colorants, reinforcing agents, adhesion mediators, impact strength modifiers, antimicrobials, and any combination thereof.

The TPU materials described above may be prepared by a process that includes the step of reacting: a) the polyisocyanate component described above; b) the polyol component described above; and c) the chain extender component described above, where the reaction may be carried out in the presence of a catalyst, resulting in a thermoplastic polyurethane composition.

TPU catalysts can be subdivided into two main categories: metal-based catalysts, typically accelerating the reaction between isocyanate and alcohol, and (tertiary) amine-based catalysts, mostly used in foaming reactions as these catalysts also promote the isocyanate-water reaction.

The metal-based catalyst may include an organo-tin catalyst, or a compound of Fe(III) or Fe(II) containing three or two anionic ligands, each formed by deprotonation of a β-diketone, a β-ketoester, a β-ketoamide, or a combination thereof. The catalyst may include a compound of Fe(III) or Fe(II) containing three or two halide counteranions each derived from chloride, fluoride, bromide, iodide, a compound resulting from the partial alcoholysis or hydrolysis of any of these compounds, or a combination thereof. The catalyst may include iron(III)-tris-2,4-pentanedionate, iron(III)-tris-(1,1,1-trifluoro-2,4-pentanedionate), iron(III)-tris-(1,1,1,5,5,5-hexafluoro-2,4-pentanedionate), iron (III)-tris-(2,2,6,6-tetramethyl-3,5-heptanedionate), iron(III)-tris-(6-methyl-2,4-heptanedionate); iron (III) chloride, iron(II)chloride, iron(III)bromide; iron(III)-tris(2,2′-bipyridine) trichloride, iron(III)-tris(1,10-phenanthroline) trichloride, or combinations thereof.

The (tertiary) amine-based catalysts function by enhancing the nucleophilicity of the diol component. The amine-based catalysts include include triethylenediamine (TEDA), dimethylcyclohexylamine (DMCHA), dimethylethanolamine (DMEA), and bis-(2-dimethylaminoethyl)ether.

A process according to embodiments of the disclosed subject matter may further include mixing the TPU composition with one or more blend components, including one or more additional TPU materials and/or polymers, including any of those described above. Optionally, the process may further include mixing the TPU composition with one or more of the additional additives described above.

In the case of a thermoplastic polyurethane powder according to one or more embodiments of the disclosed subject matter, such thermoplastic polyurethane powder can have an average particle diameter of less than 200 microns, preferably an average particle diameter of 50 to 150 microns, and especially preferably an average particle diameter of about 100 microns. The resulting thermoplastic polyurethane can have a melting enthalpy (as measured by DSC) ranging from 5.5 J/g to 100 J/g, preferably from 10 J/g to 50 J/g, and especially preferably from 15 J/g to 45 J/g. The resulting thermoplastic polyurethane can also have a Tc (crystallization temperature measured by DSC) ranging from 70° C. to 150° C., preferably from 80° C. to 140° C., and especially preferably from 90° C. to 130° C. The resulting thermoplastic polyurethane can have a A(Tm:Tc) (the difference between the Tm and Tc of the thermoplastic polyurethane where both are measured by DSC), of between 20 and 75 degrees (or a difference of at least 20, 30, 40, 50, or 58 degrees and no more than 75, 71, or even 60 degrees). In some embodiments, the thermoplastic polyurethane further has a Tm (melting temperature as measured by DSC) ranging from 120° C. to 200° C., preferably from 130° C. to 190° C., especially preferably from 140° C. to 180° C.; a weight average molecular weight, Mw, (measured by GPC) ranging from 30,000 to 150,000, preferably from 40,000 to 120,000, particularly preferably from 50,000 to 100,000, and especially preferably from 60,000 to 70,000; and/or a Mw/Mn ratio (where Mw is the weight average molecular weight and Mn is the number average molecular weight, where both are measured by GPC) ranging from 1.0 to 2.7, preferably from 1.5 to 2.6, particularly preferably from 1.7 to 2.5, and especially preferably from 1.8 to 2.0.

In the composition according to one or more embodiments, an amount of the thermoplastic polyurethane, based on the entire composition, ranges from 50 to 94 wt %, preferably from 60 to 85 wt %, and especially preferably from 70 to 80 wt %.

Nanostructures

As noted above, nanostructures according to embodiments of the disclosed subject matter can be carbon nanostructures. For example, in one or more embodiments of the disclosed subject matter, the nanostructures can be carbon nanostructures in the form of cylindrical nanostructures having graphene layers arranged as stacked cones, cups, or plates. Carbon nanofibers with graphene layers wrapped and arranged as cylinders are commonly referred to as carbon nanotubes. Carbon nanofibers may be produced either in a vapor-grown form or by electro spinning. Vapor-grown carbon nanofibers may be in the form of a free-flowing powder (e.g., wherein 99% of the carbon mass is in a fibrous form) known as multi-walled carbon nanotubes (MWCN) or stacked up carbon nanotubes (SCCNT) where the graphene plane surface is canted from the fiber axis, thus exposing the plane edges present on the interior and exterior surfaces of the carbon nanotubes, and may be produced by the floating catalyst method in the vapor phase by decomposing carbon-containing gases, such as methane, ethane, acetylene, carbon monoxide, benzene, and coal gas, in presence of floating metal catalyst particles inside a high-temperature reactor. Ultrafine particles of the catalyst may be either carried by the floating gas into the reactor or produced directly in the reactor by decomposing of the catalyst precursor. One such catalyst is iron, which may be produced by the decomposition of ferrocene. However other metals alone or in combination may be utilized as well as catalysts.

Carbon nanofibers suitable for embodiments of the disclosed subject matter may have an average diameter in the range of from about 20 to about 150 nm, preferably of from about 60 to about 150 nm, depending upon the grade and may have lengths of, for example, in the range of from about 3 to about 100 microns, preferably of from about 30 to about 100 microns.

Carbon nanofibers may undergo post treatment after production, including removing impurities on their surface, such as tar and other aromatic hydrocarbons, by a process called pyrolytic stripping, that involves heating, for example, to about 1000° C. in a reducing atmosphere. Sometimes heating, for example, to 3000° C. may be used to impart higher tensile strength and tensile modulus by graphitizing the surface of the carbon fibers. However, the heat treatment which may achieve an improved combination of mechanical and electrical properties may be found at a temperature of, for example, about 1500° C. In embodiments of the composites, commercially available sources of suitable carbon nanofibers may be obtained, for example, from Applied Sciences Inc. as grade PR-24XT-LHT, PR-25XT-LHT as well as Aldrich product 719803, Grupo Antolin carbon nanofibers (GANF1 and GANF3).

In some embodiments, the carbon nanotube is selected from single-walled carbon nanotubes, multi-wall carbon nanotube, hydroxylated modified single arm carbon nanotube, carboxylated modified single arm carbon nanotube, amino modified single arm carbon nanotube, hydroxylated multi-arm carbon nanotube, carboxylated multi-arm carbon nanotube, amino modified multi-arm carbon nanotube, nitrogen-doped single-arm carbon nanotube, sulfur-doped single-arm carbon nanotube, boron doped single arm carbon nanotube, nitrogen-doped multi-arm carbon nanotube, and sulfur-doped arm carbon nanotube. Therefore, the carbon nanotube can further improve the conductive plastic conductive capacity and stability.

In the composition, an amount of the carbon nanostructures, based on the entire composition, ranges from 1 to 20 wt %, preferably from 2 to 15 wt %, especially preferably from 5 to 10 wt %.

Graphite Microparticles Coated with Metals

A size of the graphite microparticles coated with metals according to one or more embodiments of the disclosed subject matter may be from 10 μm to 100 μm, however, the size is not limited thereto. The size of the graphite coated metal microparticle, for example, may be from 10 μm to 100 μm, from 20 μm to 90 μm, from 30 μm to 80 μm, from 40 μm to 70 μm, or from 50 μm to 60 μm.

The graphite microparticles coated with metals can comprise at least one metal selected from the group consisting of Ni, Cu, Al, Ti, W, Fe, Co, Zn, Si, Ag, Au, Pt, Pd, Cd, Ta and any combination thereof. Preferably, graphite microparticles coated with metals are nickel coated graphite.

In compositions according to one or more embodiments of the disclosed subject matter, an amount of the graphite microparticles coated with metals, based on the entire composition, can range from 5 to 30 wt %, preferably from 10 to 25 wt %, especially preferably from 15 to 20 wt %.

A weight ratio of the metal to the graphite can be from 1:100 to 100:1, preferably from 10:90 to 90:10, especially preferably from 20:80 to 80:20, and particularly preferably about 75:25.

In another embodiment, the composition may further comprise one or more plasticizer(s), nanoscopic particulate filler(s), and the thermal stabilizer(s). In one embodiment, the composition consists essentially of: at least one thermoplastic material comprising thermoplastic polyurethane; at least one carbon nanotube; and nickel graphite.

In another embodiment, the composition consists of: at least one thermoplastic material comprising thermoplastic polyurethane; at least one carbon nanotube; and nickel graphite.

Preferably, the composition comprises, consists essentially of, or consists of: 50 to 94 wt % of the at least one thermoplastic material comprising thermoplastic polyurethane; 1 to 20 wt % of the at least one carbon nanotube; and 5 to 30 wt % of the nickel graphite.

Particularly preferably, the composition comprises, consists essentially of, or consists of: 70 to 80 wt % of the at least one thermoplastic material comprising thermoplastic polyurethane; 5 to 10 wt % of the at least one carbon nanotube; and 15 to 20 wt % of the nickel graphite.

Especially preferably, the composition comprises, consists essentially of, or consists of: 80 wt % of the at least one thermoplastic material comprising thermoplastic polyurethane; 5 wt % of the at least one carbon nanotube; and 15 wt % of the nickel graphite.

Method of Preparing Composition

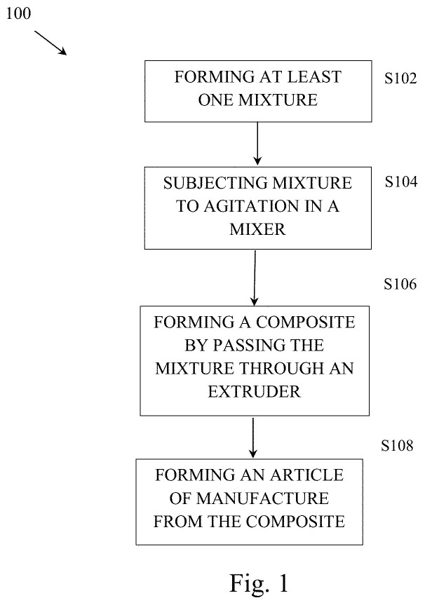

In one embodiment, such as shown in FIG. 1, the thermoplastic polymer composites can be prepared by a method 100 comprising:

In at least one embodiment, the thermoplastic polymer composites can be prepared by: (a) combining the particulate thermoplastic material comprising thermoplastic polyurethane, the electrically conductive material comprising carbon nanostructures and the graphite microparticles coated with metals in a rotary mixer to form at least one uniform mixture S102; (b) subjecting the mixture to sufficient agitation in a single/twin screw extruder under high shear and at pre-designated zonal temperatures to provide a substantially uniform dispersion S104; and (c) substantially removing the liquid dispersing medium from the dispersion of the subjecting (b) to form the composite S106. The particulate thermoplastic material and the carbon nanostructures can be distributed substantially uniformly in the composite, and/or substantially uniformly coated with the at least one graphite microparticle coated with metals, for instance.

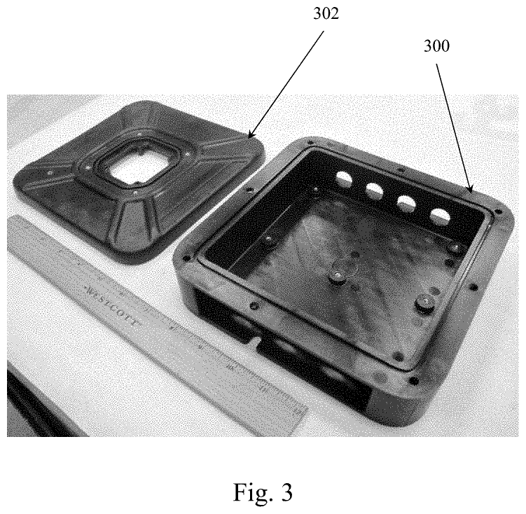

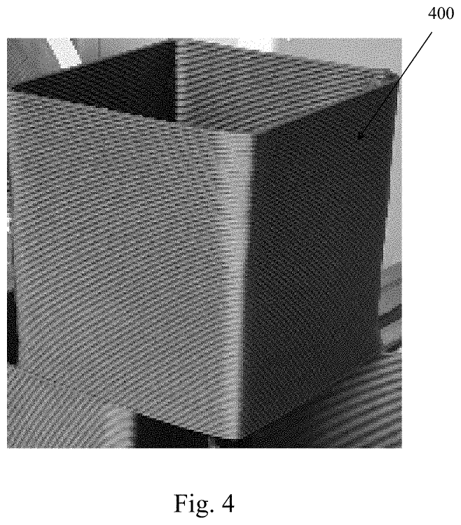

The method 100 may also comprise forming an article of manufacture from the composite S108, such as one of the examples shown in FIGS. 3-4. Of course, in one or more embodiments of the disclosed subject matter, methods may comprise providing the composite and forming the article of manufacture from the composite.

Mixing all constituents of the composition in a rotary mixer under ambient temperature before feeding to extruder hopper—may help in making the feed to the extruder more uniform.

A feature of one or more embodiments of electrically conductive polymer composites according to embodiments of the disclosed subject matter can be the formation of a conductive network formed by electrically conductive components (e.g., carbon nanotubes and graphite microparticles coated with metals) being distributed substantially uniformly in the composite during the process for preparing same, and which is partially or completely preserved during processing, for example, by extrusion of into filaments/pellets. The plasticizers and thermal stabilizers, which function as processing aids, may also aid in adherence of some or all of these electrically conductive components to each other and the particulate thermoplastic polyurethane and/or the nanoscopic particulate fillers.

Embodiments of the disclosed subject matter also relate to preparing thermoplastic polymer composites (including the above-described electrically conductive polymer composites), as well as subsequent processing of these composites to provide, for example, extruded materials, such as filaments. In this method, a mixture may be formed comprising the particulate thermoplastic polymers, all or a portion of the solid functional components (electrically conductive materials), all or a portion of the nanoscopic particulate fillers, and all or a portion of the processing additives (such as the plasticizers, and/or thermal stabilizers).

Mixing under high shear can allow uniform coverage (e.g., deposition) of processing additives onto the surface of the solids (e.g., the TPU, carbon nanotubes, metal coated graphites, etc.), as well as allowing for the formation of, for example, three dimensional electrically conductive network, when incorporating electrically conductive materials within the bulk of the composite which is largely preserved after subsequent processing, for example, by extrusion into filaments. By using high shear mixing and evaporation devices in this method enables substantially uniform distribution of the plasticizer and thermal stabilizer, as well as, for example, the solid electrically conductive materials within these composites, thus creating an electrically conductive network throughout the structure of these composites. The composites prepared in this manner may be later deposited/melted/extruded by equipment, such as a screw extruder, to yield electrically conductive articles containing a highly branched framework of conductive pathways (formed by carbon nanostructures) which may allow for higher conductivity of the resulting articles along with a relatively small load of the conductive component(s).

In particular, this process may yield a highly electrically conductive polymer composites, as well as articles made from such composites, with a very low volumetric resistivity (e.g., higher conductivity) of about 1 Ohm-cm or below. Alternatively, and by incorporating structural reinforcement materials, non-conductive reinforced thermoplastic polymer composites possessing lower electrical conductivity (higher resistivity) may be obtained, and some embodiments, electrically conductive materials (e.g., carbon nanostructures and metal nanoparticle coated with graphene graphite microparticles coated with metals) may be added in and amount below percolation threshold, will still providing such non-conductive reinforced thermoplastic polymer nanocomposites.

In another embodiment, the electrically conductive polymer composite may be prepared by a solvent route. In the solvent route, the thermoplastic polyurethane polymers may be dissolved in the appropriate solvent, such as chloroform or dichloromethane, to form a solution of the thermoplastic polyurethane polymers. The remaining components of the composite, such as the carbon nanotubes and metal coated graphite microparticles, may then be added to this solution to form a substantially uniform dispersion of these other components in this solution. The resulting dispersion may then be poured into, for example, a tray, with the solvent being removed, for example, by evaporation of the solvent, or by any other applicable technique for solvent removal. The resulting dry film of electrically conductive polymer composite may then be chopped up or ground, and then used for injection molding and SLS applications, as is or may be dispersed in appropriate media for ink-jet printing applications or may be extruded into a filament, as described above.

Another embodiment involves a method of further improving the mechanical properties (e.g., strength) of these printed conductive architectures by post-processing techniques that enable printed or molded components or parts to be further mechanically altered by drilling, sawing, sanding, or polishing, without significant softening, melting, or disintegrating of the component or part. Upon exiting extruder, the extruded material may be cooled relatively fast before it is collected and spooled. Therefore, the extruded material comprising the thermoplastic polyurethane polymers may be amorphous or substantially amorphous, with a relatively low glass transition (Tg) temperature and thus may be lacking any significant mechanical strength. These lower crystallization rates along with lower glass transition (Tg) temperature of the thermoplastic polymers present in these composites may thus limit those applications of these composites where certain mechanical properties may be required. Therefore, increasing the degree of crystallinity of these thermoplastic polymers in these composites may be desirable for improving the mechanical properties of such composites.

### Examples of Applications

Examples of uses for these electrically conductive composites (including structurally reinforced electrically conductive polymer composites) according to embodiments of the disclosed subject matter can include, for example: printed electronic circuitry (e.g., circuit boards); conductive traces; flexible circuits; membrane switches; keypads; improved electrodes for rechargeable lithium-ion batteries; thin film batteries; heat sinks for semiconductor laser diodes; roll to roll thick film printing of 3D current conductors; reduction or total replacement of metals in 3D composites such as lightweight, high strength aircraft parts; support structures, and catalyst supports.

Examples of commercial applications of these electrically conductive polymer composites (including structurally reinforced electrically conductive polymer composites) may include, for example: solar cell grid collectors, lightning surge, protection, electromagnetic interference shielding (EMI shielding), electromagnetic radiation shields, electrostatic shields, flexible displays, photovoltaic devices, smart labels, myriad electronic devices (music players, games, calculators, cellular phones), decorative and animated posters, active clothing, and RFID tags.

Embodiments these electrically conductive polymer composites may be suitable, for example, for creating “printed conductive circuitry” that may, for example, be deposited, or may be printed using a variety of modern techniques, such as 3D printing, inkjet printing, selective laser sintering (SLS), fused deposition modeling (FDM), injection molding, and other methods. For example, complete conductive circuits, and pathways may be imbedded into an insulating frame or casing and may be printed in one continuous process, easing dramatically the production and assembly of the final component, part or article. These printed conductive pathways may be used to create integrated electrical circuitry (e.g., as printed circuit boards), heat sinks, ion batteries, (super)capacitors, antennae (e.g., RFID tags), electromagnetic interference shielding, electromagnetic radiation shields, solar cell grid collectors, electrostatic shields, or any other application where conductors of electrical current are used. The ability of these electrically conductive polymer composites to be printed together with other components of the final article, component, part, etc., makes their use advantageous compared to other methods (e.g., lithography) due to: higher throughput since all materials may be printed on the same equipment (e.g., printer); better compatibility between components since all materials are polymer based; ability to create complex three-dimensional (3D) structures; ability to seamlessly integrate conductive circuits into the bulk of the final product; simultaneous incorporation of components with single or multiple functionalities; ease of production, since all components may be produced in one process without or minimum post-printing treatment, etc. Alternatively, structurally reinforced non-conductive thermoplastic polymer composites may be formed by such techniques for articles used in, for example, automotive industries, aerospace industries, sports industries.

FIGS. 3 and 4 show examples of articles of manufacture that may be made using compositions according to embodiments of the disclosed subject matter and techniques according to embodiments of the disclosed subject matter. More specifically, FIG. 3 shows an article of manufacture in the form of an enclosure 300 and an article of manufacture in the form of a cover 302 for the enclosure 300, and FIG. 4 shows an article of manufacture in the form of a support structure.

As alluded to above, embodiments of the disclosed subject matter can be created using or involve a three-dimensional printing method comprising printing a three-dimensional part comprising a composition according to the disclosed subject matter. Additionally, or alternatively, embodiments of the disclosed subject matter can be created using or involve an injection molding method comprising injecting composition according to the disclosed subject matter into a mold and processing to create an injection molded article of manufacture. In one or more embodiments, the article may be in the form of a plating on a surface of another article, for instance, to create an EMI shield. Thus, one or more embodiments can involve: a three-dimensional printing method, comprising printing a three-dimensional part comprising the composition according to embodiments of the present disclosure; injection molding a three-dimensional part comprising injecting a composition according to embodiments of the present disclosure into a mold; or a method for electromagnetic interference shielding of a material, comprising plating a compositing according to embodiments of the present disclosure onto a surface of a structure.

Fused Deposition Modeling (FDM) and other Three-Dimensional (3D) Printing

Three-dimensional (3D) additive manufacturing techniques may be used to extrude filaments prepared from these electrically conductive polymer composites through a nozzle and onto a supporting substrate. The precisely controlled (computer controlled) motion of the nozzle in such 3D printing allows polymer deposition in three dimensions. FDM printing may differ from other 3D printing techniques in using a supportive polymer structure, which may be removed after the model is complete, while other 3D printing techniques may not have to use such supports. These electrically conductive polymer composites may be produced, as described in embodiments of the present disclosure, to be conductive, magnetic, and reinforced, or a combination of such properties, in the form of filaments to fit currently available 3D printers. The compositions of these polymer composites may be altered to enable extrusion of these filaments at conditions used in those printers (e.g., by using plasticizers and other additives). For example, electrically conductive polymer composites may be coprinted together with other non-conductive plastics using multi-nozzle printers, thus building an entire product in one continuous process using a single computer model.

Selective Laser Sintering (SLS)

These electrically conductive polymer composites may also be useful in powdered form (for example by grinding/milling the extruded conductive composite filament) in SLS and similar 3D printing techniques which may enable the production of complex three-dimensional (3D) structures using these polymer composites. These polymer composites may be used in the form of a powdered material which may be heated in the focal point of a laser source, resulting in the local melting and sintering the polymer composite particles together. The movement of the laser focal point in the XY plane, together with the movement of the base containing the polymer precursor in the Z direction, may result in the formation of a 3D object.

Inkjet Printing

These electrically conductive polymer composites may also be useful in inkjet printing, wherein the composite may be deposited through the expulsion of a liquid solution (i.e., composites dissolved, dispersed, etc., in a liquid solvent) thereof from a container under high pressure in the form of small droplets into and onto substrate. Once on the substrate, the solvent may be quickly dried leaving these electrically conductive polymer composites adhered to the surface. Alternatively, the use of solvent may be avoided by using photo-curable materials such as inks, which are liquid in the initial form and which may be printed into or onto the substrate using conventional jet printing methods. Once on the surface, these curable inks may be exposed to light (such as UV light), resulting in the formation of an electrically conductive polymer composite film. These electrically conductive polymer composites may be prepared in the form of an ink suitable for inkjet printing by using, for example, quick drying solvents. For example, the use of ethyl cellulose as a dispersant may enable a very high carbon loading (in the case of these electrically conductive polymer composites) without a significant increase in viscosity, which may be desirable for creating highly conductive and printable inks. These electrically conductive polymer composite dispersions may be also introduced into monomer or oligomer blends containing photoinitiators, electroinitiators, or thermal initiators, thus resulting in a conductive curable ink.

Properties

Tensile Strength

The composition used according to the present disclosure has a tensile strength ranging from 4000 to 8000 PSI, preferably from 6000 to 7800 PSI, particularly preferably from 6500 to 7700 PSI, especially preferably from 7000 to 7600 PSI, as measured by ASTM D638.

Tensile Modulus

The composition used according to the present disclosure has a tensile modulus ranging from 150 to 350 ksi, particularly preferably from 300 to 340 ksi, particularly preferably from 315 to 330 ksi, as measured by ASTM D638. More specifically, when injection molded, the tensile modulus can range from 200 to 350 ksi, as measured by ASTM D638. When 3D printed, the tensile modulus can range from 125 to 250 ksi as measured by ASTM D638.

Tensile Elongation

The composition used according to the present disclosure has a tensile elongation ranging from 10%-50%, preferably from 15 to 40%, particularly preferably from 20 to 30%, especially preferably about 25%, as measured by ASTM D638.

Flexural Strength

When injection molded, the composition used according to the present disclosure has a flexural strength ranging from 3000-7000 psi, preferably from 5000 to 6800 psi, particularly preferably from 6000 to 6750 psi, especially preferably from 6250 to 6500 psi, as measured by ASTM D790. When 3D printed, the composition used according to the present disclosure has a flexural strength ranging from 3000-6000 psi, preferably from 4000 to 5500 psi, as measured by ASTM D790.

Flexural Modulus

When injection molded, the composition used according to the present disclosure has a flexural modulus ranging from 200-300 ksi, preferably from 225-275 ksi, particularly preferably from 240 to 250 ksi, as measured by ASTM D790. When 3D printed, the composition used according to the present disclosure has a flexural modulus ranging from 100-250 ksi, as measured by ASTM D790.

Un-Notched Impact

When injection molded, the composition used according to the present disclosure has an un-notched impact resulting in “No-Break,” as measured by ASTM D 4812. When 3D printed, the composition used according to the present disclosure has an un-notched impact resulting in “No-Break,” as measured by ASTM D 4812.

Notched Impact

The composition used according to the present disclosure has a notched impact ranging from 2 to 14 ft/lb/in., preferably from 2.1 to 10 ft/lb/in., particularly preferably from 2.2 to 5 ft/lb/in., especially preferably from 2.3 to 3 ft/lb/in., as measured by ASTM D256. When 3D printed, the composition used according to the present disclosure has a notched impact resulting in 4 to 20 ft/lb/in, as measured by ASTM D256.

Specific Gravity

The composition used according to the present disclosure has a specific gravity ranging from 1.30 to 1.45, preferably from 1.35 to 1.40, as measured by as measured by ASTM D792.

MAX EMI Shielding

The composition used according to the present disclosure has a maximum EMI SE ranging from 40 to 60 dB, preferably from 45 to 58 dB, particularly preferably from 50 to 55 dB at 1.5 GHZ as measured by as measured by ASTM D4935.

Resistivity

When injection molded, the composition used according to the present disclosure has a resistivity of 0.2 to 0.9 ohm-cm, particularly preferably from 0.25 to 0.7 ohm-cm, particularly preferably from 0.3 to 0.5 ohm-cm, as measured by 4-point Method. Preferably, the resistivity is less than 0.5 ohm-cm. When 3D printed, the composition used according to the present disclosure has a resistivity, as measured by 4-point Method, of from 0.5-1.3 ohm-cm.

Sheet Resistance

When injection molded, the composition used according to the present disclosure has a sheet resistance ranging from 0.6 to 1.2 ohm/sq. as measured by 4-point Method. Preferably, the sheet resistance is less than 1 ohm/sq. When 3D printed, the composition used according to the present disclosure has a resistivity, as measured by 4-point Method, of from 0.5 to 4 ohm/sq.

Melt Flow Rate

The composition used according to the present disclosure has a melt flow rate ranging from 2 to 15 grams/10 min, particularly preferably from 5 to 10 grams/10 min, as measured by ASTM D1238.

### EXAMPLES

### Inventive Example 1: A Mixture of Graphite Microparticles Coated with Metals, the Carbon Nanotubes, and the TPU Manufacturing

Ni-Graphite at 15 wt %, the multi-walled carbon nanotubes (MWCNT) at 5 wt %, and the thermoplastic polyurethane (polyester-based Avalon 60 DB from Huntsman) at 80 wt %, were provided and put into a mixer, and then uniformly mixed for 30 s at 2000 rpm to manufacture the mixture of the Ni-Graphite microparticles, the carbon nanotubes, and the TPU. The Ni-Graphite microparticles, carbon nanotube and TPU mixture were supplied to the extruder through a hopper. The supplied mixture were melted and kneaded in the extruder and spun through a spinning nozzle. In this case, a screw temperature of the extruder was from 200 to 220° C. The spun filament was cooled in air at a cooling part, and then the filament that was stretched in a stretching roll was wound to a bobbin to manufacture the Ni-Graphite microparticle/carbon nanotube/TPU filament.

The Ni-Graphite microparticle/carbon nanotube/TPU compound was injection molded in to a 5.5″ dia. disk having a thickness of 4 mm, and the shielding effectiveness was tested at 1.5 GHz by ASTM D4935.

The Ni-Graphite microparticle/carbon nanotube/TPU compound was used to injection mold number of Dog-bone test coupons to measure tensile strength (psi), tensile modulus (ksi), tensile elongation (%), flexural strength (psi), flexural modulus (ksi), un-notched impact (ft-lb/in), notched impact (ft-lb/in), specific gravity, resistivity (ohm-cm) and sheet resistance (ohm/sq.), which are shown in Table 1.

### Comparative Example 1: RTP TDS 1200 S-65D TPU “NEAT”

An ester-based thermoplastic polyurethane elastomer (RTP TDS 1200 S-65D) from RTP Company was injection molded, and the shielding effectiveness was tested by ASTM D4935. The tensile strength (psi), tensile modulus (ksi), tensile elongation (%), flexural strength (psi), flexural modulus (ksi), un-notched impact (ft-lb/in), notched impact (ft-lb/in), specific gravity, MAX EMI Shielding up to 1.5 GHz (4 mm THK), resistivity (ohm-cm) and sheet resistance (ohm/sq) were measured and are shown in Table 1.

TABLE 1

| | Injection Molded | |
|---|---|---|
| | RTP TDS | |
| | 1200 S-65D | LM Custom Compound |
| | TPU | TPU + 5% CNS + 15% |
| Material Properties | “NEAT” | Ni-Graphite |
| Tensile strength (psi) | 6400 | 7700 |
| Tensile Modulus (ksi) | N/A | 327 |
| Tensile Elongation (%) | 390 | 22 |
| Flexural Strength (psi) | N/A | 6531 |
| Flexural Modulus (ksi) | 37 | 247 |
| Un-Notched impact | N/A | No Break |
| (ft-lb/in) | | |
| Notched impact (ft-lb/in) | N/A | 2.34 |
| Specific Gravity | 1.22 | 1.39 |
| MAX EMI SE up to 1.5 GHz | None | 57.5 |
| (4 mm THK) | | |
| Resistivity (ohm-cm) | OVERLOAD | 0.252 |
| Sheet Resistance (ohm/sq) | OVERLOAD | 0.631 |

As demonstrated in Table 1, Example 1 resulted in superior tensile strength, tensile modulus, tensile elongation (%), flexural strength, flexural modulus, un-notched impact, notched impact, specific gravity, conductivity, EMI shielding, resistivity, and sheet resistance properties compared to RTP TDS 1200 S-65D of Comparative Example 1.

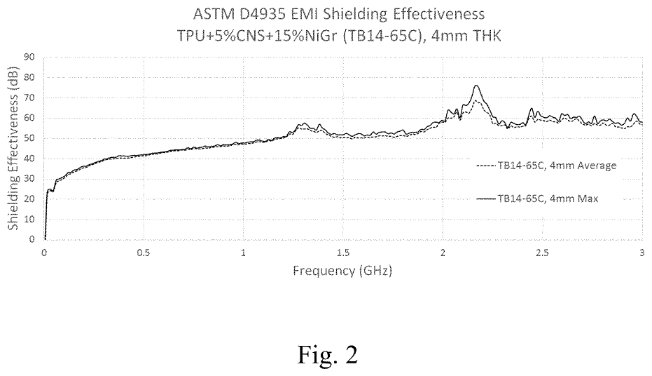

FIG. 2 is a graph demonstrating showing EMI shielding effectiveness of Example, which is an embodiment according to the disclosure. The x-axis represents frequency (in GHz), and the y-axis represents attenuation (in dB). Generally, FIG. 2 demonstrates the EMI shielding effectiveness of the 4 mm average and the 4 mm maximum of several samples of Example 1.

Compositions according to embodiments of the present disclosure can achieve novel conductive toughness thermoplastics, for instance, for injection molding and/or 3D printing articles of manufacture that exhibit desirable electrical performance characteristics (e.g., ESD, EMI, RFI), which may be tailored to a specific application. Furthermore, articles of manufacture made using compositions according to embodiments of the disclosed subject matter can exhibit desirable mechanical properties, such as impact resistance, improved specific strength/modulus, low weight, and improved dimensional stability and service life, for instance, as compared to metal plated thermoplastics. Thus, embodiments of the disclosed subject matter can provide for a low-cost alternative to metal plated thermoplastics.

### Definitions

The term “thermoplastic” refers to the conventional meaning of thermoplastic, which is a composition, compound or material that exhibits the property of a material, such as a high polymer, that softens or melts so as to become pliable or malleable, when exposed to sufficient heat and generally returns to its original condition when cooled to room temperature.

The term “filament” refers to a continuous length of material which has a thread-like structure, having a length which greatly exceeds its diameter and which may be used with fused filament fabrication (FFF) printer. A filament may be solid or may be fluid, i.e., when liquefied, molten, melted, or softened.

The term “thermoplastic polyurethane” refers to polyurethanes that are thermoplastic. Suitable thermoplastic polyurethanes for use herein are generally derived from (a) a polyisocyanate component, (b) a polyol component, and (c) an optional chain extender component.

The term “electrically conductive” refers to materials which have properties and capabilities to conduct an electric current. Electrically conductive materials may include metals and carbon materials, such as carbon nanofibers, graphene nanoplatelets, as well as combinations thereof.

The term “solid functional components” refers to one or more of the solid electrically conductive materials or solid structural reinforcement materials.

The term “electrically conductive network” can refer to a conductive network that is formed by electrically conductive materials that may be present in a composite according to one or more embodiments of the disclosed subject matter.

The term “carbon material” refers to materials made of carbon, and which may function as one or more of: electrically conductive materials, structural reinforcement materials, and nanoscopic particulate fillers. Carbon materials may include one or more of: carbon nanofibers (including carbon-based nanotubes); graphite; graphite flakes; carbon black; graphene; and graphene-like materials (e.g., reduced graphene oxide, functionalized graphene, graphene oxide, particularly reduced graphene oxide).

The term “graphene-like material” refers to a material or substance, which may have a layered structure the same or similar to graphene. Graphene-like materials may include one or more of: graphene; functionalized graphene; graphene oxide; partially reduced graphene oxide; graphite flakes; and graphene nanoplatelets.

The term “graphene” refers to pure or relatively pure carbon in the form of a relatively thin, nearly transparent sheet, which is one atom in thickness (i.e., a monolayer sheet of carbon), or comprising multiple layers (multilayer carbon sheets), having a plurality of interconnected hexagonal cells of carbon atoms, most of which are present in sp² hybridized state and which form a honeycomb like crystalline lattice structure. In addition to hexagonal cells, pentagonal and heptagonal cells (defects) may also be present in this crystal lattice.

The term “functionalized graphene” refers to graphene which has incorporated into the graphene lattice a variety of chemical functional groups, such as —OH, —COOH, or —NH₂, in order to modify the properties of graphene.

The term “graphene nanoplatelets (NGPS)” and “nanosheets” can refer interchangeably to platelets of graphene, and may also refer to platelets and sheets comprised of other graphene-like materials such as graphene oxide, partially reduced graphene oxide, or functionalized graphene, having a thickness in the range of from about 0.34 to about 100 nm and may include one material or in any combination.

The term “nanoscopic” refers to materials, substances or structures having a size in at least one dimension (diameter, thickness) of from about 1 to 1000 nanometers, such as from about 1 to about 100 nanometers. Nanoscopic materials, substances, and structures may include, for example, nanoplatelets, nanotubes, nanowhiskers, and flakes.

The term “flakes” refers to particles in which two of the dimensions (i.e., width and length) are significantly greater as compared to a third dimension (i.e., thickness).

The term “conductive metal nanoparticulates” refers to nanoscopic particulates which are formed from electrically conductive metals such as silver, copper, nickel, or aluminum, or combinations of such metals, and which may be dispersed in a medium, such as a paste, paint, or ink.

The term “liquid dispersing medium” refers to a liquid which may dissolve, suspend, etc., another material which may be a solid, gas, or liquid. The liquid dispersion medium may be solvents, mixtures of solvents, as well as any other substance, composition, compound, etc., which exhibits liquid properties at room or elevated temperatures, etc., and which may be also relatively volatile. Suitable for use as the liquid dispersing medium in the method of the present disclosure for preparing electrically conductive polymer composites may include one or more of: acetone, ethanol, methanol, chloroform, and dichloromethane.

The term “plasticizer” refers to the conventional meaning of this term as an additive which, for example, softens, makes more flexible, malleable, pliable, or plastic, a polymer, thus providing flexibility, pliability, and durability, which may also decrease the melting and the glass transition temperature of the polymer, and which may include, for example, one or more of: tributyl citrate; acetyl tributyl citrate; diethyl phthalate; glycerol triacetate; glycerol tripropionate; triethyl citrate, acetyl triethyl citrate; phosphate esters (e.g., triphenyl phosphate, resorcinol bis(diphenyl phosphate), olicomeric phosphate, etc.); long chain fatty acid esters; aromatic sulfonamides; hydrocarbon processing oil; propylene glycol; epoxy-functionalized propylene glycol; polyethylene glycol; polypropylene glycol; partial fatty acid ester (Loxiol GMS 95); glucose monoester (Dehydrat VPA 1726); epoxidized soybean oil; acetylated coconut oil; linseed oil; and epoxidized linseed oil.

The term “melt strength” refers to the resistance of the melted polymer composite to stretching and reflect how strong the polymer composite is when in a molten state. Melt strength of the melted polymer composite is related to the molecular chain entanglements of the polymer in the composite and its resistance to untangling under strain. The polymer properties affecting such resistance to untangling include, for example, molecular weight, molecular-weight distribution (MWD), and molecular branching. As each of these properties increase, melt strength of the polymer may be improved.

The term “extrudable” refers to composition, compound, substance, or material, which is sufficiently malleable, pliable, or thermoplastic, such that it may be forced through an extrusion orifice or die.

The term “fusible” refers to a thermoplastic composition, substance or material which may be fused, sintered, joined together, or combined by the application of heat.

The term “three-dimensional (3D) printable material” refers to a thermoplastic composition, substance, or material, which may be formed into a three-dimensional (3D) article, device, component, object, structure, or part, by a three-dimensional (3D) printing technique.

The term “substantially uniform” refers to a composition, dispersion, material or substance which is substantially uniform in terms of composition, texture, characteristics and properties.

The term “dispersion” refers to a two (or more)-phase system which may be for, example, in the form of an suspension or a colloid, in which solid materials (e.g., solid particulates, solid particles, solid powders) are dispersed or suspended in the external or continuous (bulk) phase (e.g., the liquid dispersion medium).

The term “room temperature” refers to the commonly accepted meaning of room temperature (an ambient temperature of from about 20° to about 25° C.).

Embodiments of the disclosed subject matter may also be as set forth according to the parentheticals in the following paragraphs.

(1) A composition comprising an electrically conductive polymer composite, the composite including: at least one thermoplastic material comprising thermoplastic polyurethane; at least one electrically conductive material comprising carbon nanostructures; and at least one graphite microparticle coated with metals.

(2) The composition according to (1), wherein the carbon nanostructures are carbon nanotubes.

(3) The composition according to (1) or (2), wherein the at least one graphite microparticle is coated with nickel.

(4) The composition according to any one of (1) to (3), comprising: at least one thermoplastic material comprising thermoplastic polyurethane; at least one carbon nanotube; and nickel graphite.

(5) The composition according to any one of (1) to (4), comprising, based on the entire composition: 50 to 94 wt % of the at least one thermoplastic material comprising thermoplastic polyurethane; 1 to 20 wt % of the at least one carbon nanotube; and 5 to 30 wt % of the nickel graphite.

(6) The composition according to any one of (1) to (5), comprising, based on the entire composition: 70 to 80 wt % of the at least one thermoplastic material comprising thermoplastic polyurethane; 5 to 10 wt % of the at least one carbon nanotube; and 15 to 20 wt % of the nickel graphite.

(7) The composition according to any one of (1) to (6), consisting of, based the entire composition: 80 wt % of the at least one thermoplastic material comprising thermoplastic polyurethane; 5 wt % of the at least one carbon nanotube; and 15 wt % of the nickel graphite.

(8) A method of preparing a composition comprising an electrically conductive polymer composite, the composite including: at least one thermoplastic material comprising thermoplastic polyurethane; at least one electrically conductive material comprising carbon nanostructures; and at least one graphite microparticle coated with metals (Ni-Graphite), the method comprising: (a) combining the particulate thermoplastic material comprising thermoplastic polyurethane, the electrically conductive material comprising carbon nanostructures, and the at least one graphite microparticle coated with metals (e.g., Ni-Graphite) to pass through a mixer to form uniform feed to the extruder; and (b) subjecting the mixture to sufficient agitation under high shear in the extruder to provide a substantially uniform dispersion, where the particulate thermoplastic material and the carbon nanostructures are distributed substantially uniformly in the composite, and substantially uniformly mixed with Ni-Graphite microparticles.

(9) The method according to any one of (1) to (8), wherein the carbon nanostructures are carbon nanotubes.

(10) The method according to any one of (1) to (9), wherein the at least one graphite microparticle coated with metals is nickel graphite.

(11) The method according to any one of (1) to (10), wherein the composition comprises: at least one thermoplastic material comprising thermoplastic polyurethane; at least one carbon nanotube; and nickel graphite.

(12) The method according to any one of (1) to (11), wherein the composition comprises, based on the entire composition: 70 to 80 wt % of the at least one thermoplastic material comprising thermoplastic polyurethane; 5 to 10 wt % of the at least one carbon nanotube; and 15 to 20 wt % of the nickel graphite.

(13) The method according to any one of (1) to (12), wherein the composition consists of, based on the entire composition: 80 wt % of the at least one thermoplastic material comprising thermoplastic polyurethane; 5 wt % of the at least one carbon nanotube; and 15 wt % of the nickel graphite.

(14) The method according to any one of (1) to (13), further comprising forming an article of manufacture from the composition.

(15) A method of forming a three-dimensional article of manufacture from a composition comprising an electrically conductive polymer composite, the composite including: at least one thermoplastic material comprising thermoplastic polyurethane; at least one electrically conductive material comprising carbon nanostructures; and at least one graphite microparticle coated with nickel, graphite coated with metals, the method comprising: providing the composition; and forming the three-dimensional article of manufacture out of the provided composition.

(16) The method according to (15), wherein said providing the composition includes injecting the composition into a mold.

(17) The method according to (15) or (16), wherein said forming the three-dimensional article of manufacture is via injection molding.

(18) The method according to any one of (15) to (17), wherein the three-dimensional article of manufacture is one of a cover for an enclosure or a support structure.

(19) The method according to any one of (15) to (18), wherein said forming the three-dimensional article of manufacture is via additive manufacturing.

(20) The method according to any one of (15) to (19), wherein the additive manufacturing is Big Area Additive Manufacturing (BAAM).

Having now described embodiments of the disclosed subject matter, it should be apparent to those skilled in the art that the foregoing is merely illustrative and not limiting, having been presented by way of example only. Thus, although particular configurations have been discussed and illustrated herein, other configurations can be and are also employed. Further, numerous modifications and other embodiments (e.g., combinations, rearrangements, etc.) are enabled by the present disclosure and are contemplated as falling within the scope of the disclosed subject matter and any equivalents thereto. Features of the disclosed embodiments can be combined, rearranged, omitted, etc., within the scope of described subject matter to produce additional embodiments. Furthermore, certain features may sometimes be used to advantage without a corresponding use of other features. Accordingly, Applicant intends to embrace all such alternatives, modifications, equivalents, and variations that are within the spirit and scope of the present disclosure. Further, it is therefore to be understood that within the scope of the appended claims, the disclosure may be practiced otherwise than as specifically described herein.

1. A composition comprising an electrically conductive polymer composite, the composite including:
at least one thermoplastic material comprising thermoplastic polyurethane;
at least one electrically conductive material comprising carbon nanostructures; and
at least one graphite microparticle coated with at least one metal.

2. The composition according to claim 1, wherein the carbon nanostructures are carbon nanotubes.

3. The composition according to claim 1, wherein the at least one graphite microparticle coated with at least one metal is nickel graphite.

4. The composition according to claim 1, comprising:
at least one thermoplastic material comprising thermoplastic polyurethane;
at least one carbon nanotube; and
nickel graphite.

5. The composition according to claim 4, comprising, based on the entire composition:
50 to 94 wt % of the at least one thermoplastic material comprising thermoplastic polyurethane;
1 to 20 wt % of the at least one carbon nanotube; and
5 to 30 wt % of the nickel graphite.

6. The composition according to claim 4, comprising, based on the entire composition:
70 to 80 wt % of the at least one thermoplastic material comprising thermoplastic polyurethane;
5 to 10 wt % of the at least one carbon nanotube; and
15 to 20 wt % of the nickel graphite.

7. The composition according to claim 4, consisting of, based the entire composition:
80 wt % of the at least one thermoplastic material comprising thermoplastic polyurethane;
5 wt % of the at least one carbon nanotube; and
15 wt % of the nickel graphite.

8. A method of preparing a composition comprising an electrically conductive polymer composite, the composite including: at least one thermoplastic material comprising thermoplastic polyurethane; at least one electrically conductive material comprising carbon nanostructures; and at least one graphite microparticle coated with at least one metal, the method comprising:
(a) combining the particulate thermoplastic material comprising thermoplastic polyurethane, the electrically conductive material comprising carbon nanostructures, and the at least one graphite microparticle coated with at least one metal to form at least one mixture; and
(b) subjecting the mixture to sufficient agitation under high shear to provide a substantially uniform dispersion.

9. The method according to claim 8, wherein the carbon nanostructures are carbon nanotubes.

10. The method according to claim 8, wherein the at least one graphite microparticle coated with at least one metal is nickel graphite.

11. The method according to claim 8, wherein the composition comprises:
at least one thermoplastic material comprising thermoplastic polyurethane;
at least one carbon nanotube; and
nickel graphite.

12. The method according to claim 11, wherein the composition comprises, based on the entire composition:
70 to 80 wt % of the at least one thermoplastic material comprising thermoplastic polyurethane;
5 to 10 wt % of the at least one carbon nanotube; and
15 to 20 wt % of the nickel graphite.

13. The method according to claim 11, wherein the composition consists of, based on the entire composition:
80 wt % of the at least one thermoplastic material comprising thermoplastic polyurethane;
5 wt % of the at least one carbon nanotube; and
15 wt % of the nickel graphite.

14. The method according to claim 8, further comprising forming an article of manufacture from the composition.

15. A method of forming a three-dimensional article of manufacture from a composition comprising an electrically conductive polymer composite, the composite including: at least one thermoplastic material comprising thermoplastic polyurethane; at least one electrically conductive material comprising carbon nanostructures; and at least one graphite microparticle coated with at least one metal, the method comprising:
providing the composition; and
forming the three-dimensional article of manufacture out of the provided composition.

16. The method according to claim 15, wherein said providing the composition includes injecting the composition into a mold.

17. The method according to claim 15, wherein said forming the three-dimensional article of manufacture is via injection molding.

18. The method according to claim 15, wherein the three-dimensional article of manufacture is one of a cover for an enclosure or a support structure.

19. The method according to claim 15, wherein said forming the three-dimensional article of manufacture is via additive manufacturing.

20. The method according to claim 19, wherein the additive manufacturing is Big Area Additive Manufacturing (BAAM).
